(19) United States
(12) Patent Application Publication
(10) Pub. No.: US 2011/0230070 A1
(43) Pub. Date: Sep. 22, 2011

(54) CARD CONNECTOR FIXING DEVICE

(76) Inventor: Yu Sheng Su, Taipei (TW)

(21) Appl. No.: 13/051,494

(22) Filed: Mar. 18, 2011

(30) Foreign Application Priority Data
Mar. 19, 2010 (TW) 99204851

(51) Int. Cl. H01R 13/62

(52) U.S. Cl. 439/152

(57) ABSTRACT

A card connector fixing device secures an insulating body and a casing of a card connector to a circuit board. The card connector fixing device includes an insulating body, a casing, and a disconnecting mechanism. The disconnecting mechanism includes a brace with a fastener hole. The brace is positioned on a lengthwise side of the casing, and an end of the brace includes a fastener hole corresponding to an aperture in the insulating body and the casing.

### CROSS-REFERENCE TO RELATED APPLICATIONS

This application claims priority under 35 U.S.C. §119 to Taiwanese Utility Model Application No. 99204851, filed Mar. 19, 2010.

### FIELD OF INVENTION

The present invention relates to a card connector fixing device and in particular to a card connector fixing device for firmly securing a card connector to a circuit board.

### BACKGROUND

The Personal Computer Memory Card International Association (PCMCIA) is a group of companies which define and develop a standard of interface cards for use with a computer and its peripheral products. The main functions of the PCMCIA include setting a standard and specification of a memory card for use with computers. Hence, interface cards which meet the standard are known as PCMCIA cards (PC cards for short), and slots which meet the standard are known as PCMCIA slots. The aforesaid PCMCIA cards are widely used in connecting a computer (especially a notebook computer) and peripheral devices thereof. In this regard, a PCMCIA card is the best interface for a host computer with a limited volume and external peripheral devices thereof. Until now, the most important purpose of PC cards has been to facilitate data transmission of a notebook computer or serve as its local area network card, thereby saving users the hassle of carrying peripheral devices which are heavy and burdensome.

To provide a better transmission interface, the PCMCIA developed Express Cards which are more compact, of higher speed, easier to use, and more widely suitable for I/O modes than conventional PC cards. There are two types of Express Cards according to specifications, namely 34 mm-wide Express Card/34 (small card) and 54 mm-wide Express Card/54 (large card). Express Cards are inserted into card connectors in order to work.

A casing and an insulating body of a conventional card connector are fixed to a circuit board using bolts and nuts. In this way, the bolts usually penetrate the circuit board, the insulating body, and the casing from beneath the circuit board before being screwed to the nuts on the casing, respectively, so as to fix the conventional card connector to the circuit board. The nuts are likely to rotate together with the bolts, respectively, in the course of the aforesaid screwing operation to the detriment thereof. To prevent this from happening, a user has grip to give the nuts in order to screw the bolts and nuts together, and finish the assembly process smoothly. However, the extra grip on the nuts can only be effectuated at the cost of equipping the conventional card connector with more components than otherwise, not to mention that the additional components are relatively complicated, require taking intricate installation steps, and thus incur high manufacturing costs.

In another conventional card connector, the drilling of the casing is carried out prior to the tapping. However, in doing so, threads are likely to be damaged. As a result, the scrap rate of the casing thus processed is to too high to justify mass production.

### SUMMARY

The present invention has been devised in view of such technical problems, and an object of the present invention, among others, is to provide a card connector fixing device for firmly securing a card connector to a circuit board, and in a manner that the card connector fixing device is advantageously space-saving, structurally simple, easy to manufacture and assemble, and cost-saving.

The card connector fixing device includes an insulating body, a casing, and a disconnecting mechanism. The disconnecting mechanism includes a brace with a fastener hole. The brace is positioned on a lengthwise side of the casing, and an end of the brace includes a fastener hole corresponding to an aperture in the insulating body and the casing.

### BRIEF DESCRIPTION OF THE SEVERAL VIEWS OF THE DRAWINGS

The invention is described in more detail in the following with reference to the embodiments shown in the drawings. Similar or corresponding details in the Figures are provided with the same reference numerals. The invention will be described in detail with reference to the following figures of which:

FIG. 1 is an exploded view of a card connector according to the invention;

FIG. 2A is a perspective view of a casing and braces of the card connector, before assembly;

FIG. 2B is a perspective view of the casing and braces of the card connector, after assembly;

FIG. 2C is a perspective view of the card connector with a resilient element coupled thereto;

FIG. 3A is a perspective view of the card connector and an insulating body thereof, before assembly;

FIG. 3B is a perspective view of the card connector and the insulating body, after assembly;

FIG. 4A is a perspective views of the card connector and a circuit board, before assembly;

FIG. 4B is a perspective view of the card connector and the circuit board, after assembly;

FIG. 5A is an exploded view of another card connector according to the invention; and

FIG. 5B is a perspective view of the assembled card connector of FIG. 5A.

### DETAILED DESCRIPTION OF THE EMBODIMENT(S)

Although the present invention is going to be described in detail and illustrated fully hereunder with exemplary embodiments of the invention, persons skilled in the art should understand that the disclosure can be amended and still achieve the functions and effects of the present invention. Hence, it should be understood that, from the perspective of the persons skilled in the art, the description of the present invention herein serves a general illustrative purpose and should not be deemed restrictive of the present invention.

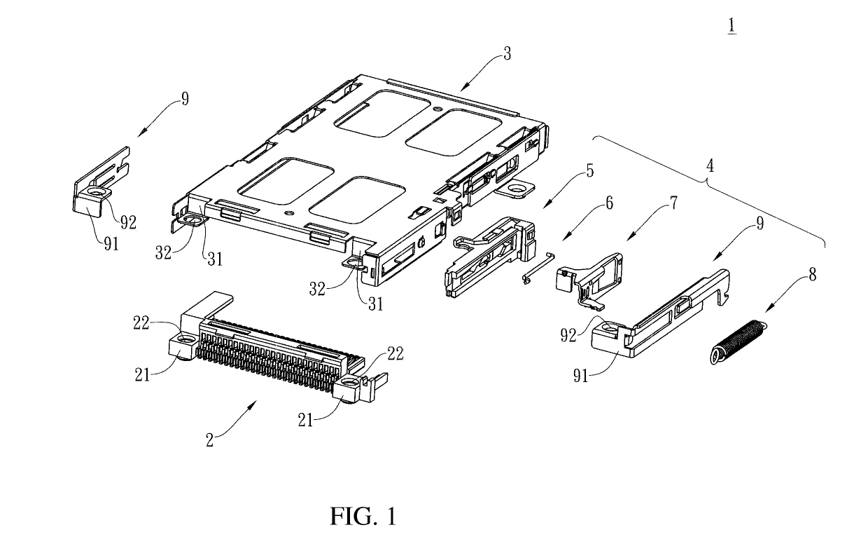

Referring to FIG. 1, there is shown an exploded view of a card connector 1 according to the invention. In the embodiment shown, the card connector 1 includes an insulating body 2, a casing 3, and a disconnecting mechanism 4 positioned on a lengthwise side of the casing 3. The disconnecting mechanism 4 includes a fixing block 5, a guiding rod 6, a sliding element 7, a resilient element 8, and a brace 9.

An extension portion 91 extends from each of the braces 9 in the widthwise and inward direction of the casing 3, such that each of the braces 9 and a corresponding one of the extension portions 91 thereof together form a substantially L-shaped body. Each of the extension portions 91 has a fastener hole 92. The casing 3 has tabs 31 corresponding in position to the extension portions 91 of the braces 9, respectively. Each of the tabs 31 has a first aperture 32 corresponding in position to a corresponding one of the fastener holes 92. The insulating body 2 has positioning portions 21 corresponding in position to the tabs 31 of the casing 3, respectively. Each of the positioning portions 21 has a second aperture 22 corresponding in position to a corresponding one of the first apertures 32. The fastener holes 92, the first apertures 32, and the second apertures 22 overlap in top-to-bottom order, respectively.

The insulating body 2, the casing 3, and the disconnecting mechanism 4 are put together to form the card connector 1, and the card connector 1 is fixed to a circuit board 10, by following the installation steps described below.

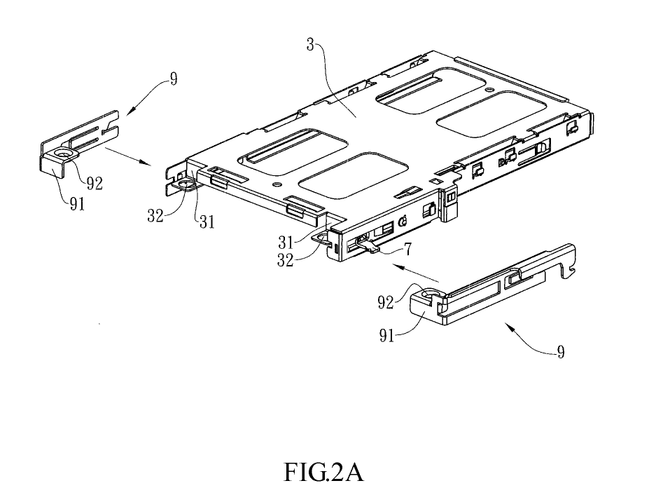

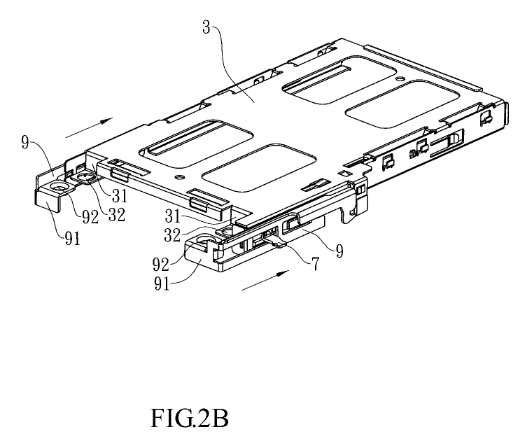

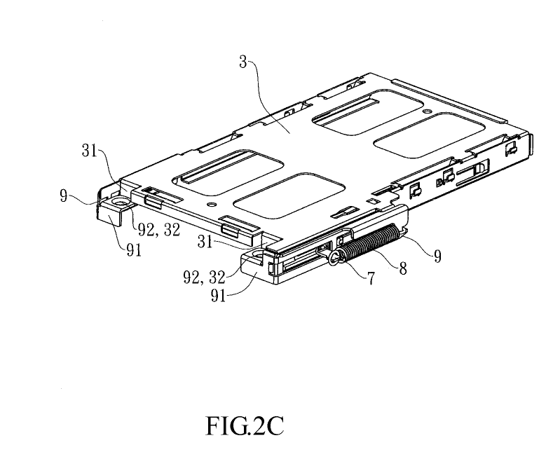

With reference to FIG. 2A through FIG. 2 C, installation of the casing 3 and the braces 9 of the card connector 1 are shown, before and after assembly.

The braces 9 are moved in the direction indicated by the arrows shown in FIG. 2A until the braces 9 become coupled to the lengthwise sides of the casing 3, respectively. Afterward, the braces 9 are slid in the direction indicated by the arrows shown in FIG. 2B. Protruding portions (not shown) are disposed from below the fastener holes 92 of the extension portions 91, respectively. Due to the protruding portions, the fastener holes 92 of the extension portions 91 can be accurately positioned at the first apertures 32 of the tabs 31, respectively. Eventually, as shown in FIG. 2C, two ends of the resilient element 8 are coupled to the sliding element 7 and the brace 9, respectively.

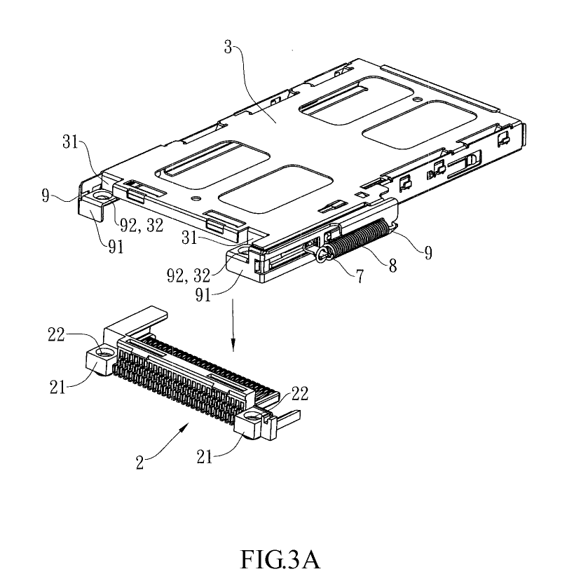

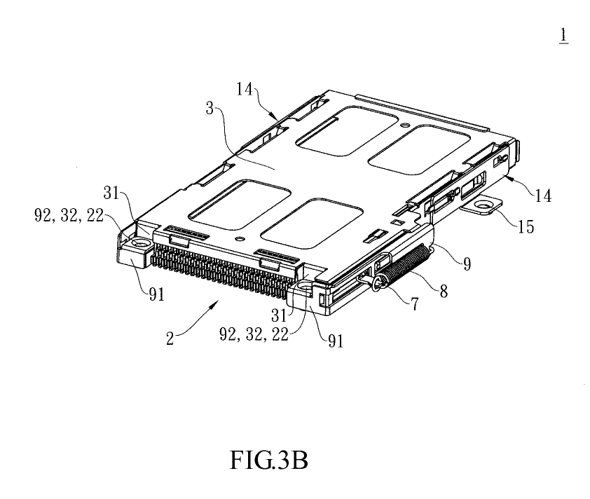

Referring to FIG. 3A and FIG. 3B, installation of the card connector 1 and the insulating body 2 thereof are shown, before and after assembly, respectively. The casing 3 is moved in the direction indicated by the arrow shown in FIG. 3A until the fastener holes 92 and the first apertures 32 are positioned on the second apertures 22, respectively, and until the casing 3 and the insulating body 2 are coupled together. The fastener holes 92, the first apertures 32, and the second apertures 22 overlap in top-to-bottom order, respectively. As shown in FIG. 3B, a base 14 is positioned on each of the lengthwise sides of the casing 3 of the card connector 1 and positioned distal to the insulating body 2 (that is, positioned proximal to the card slot), and the base 14 has a fastener hole 15.

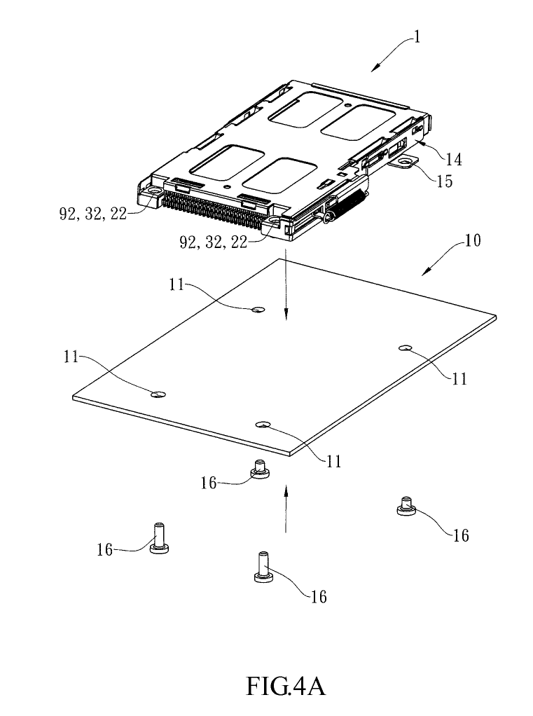

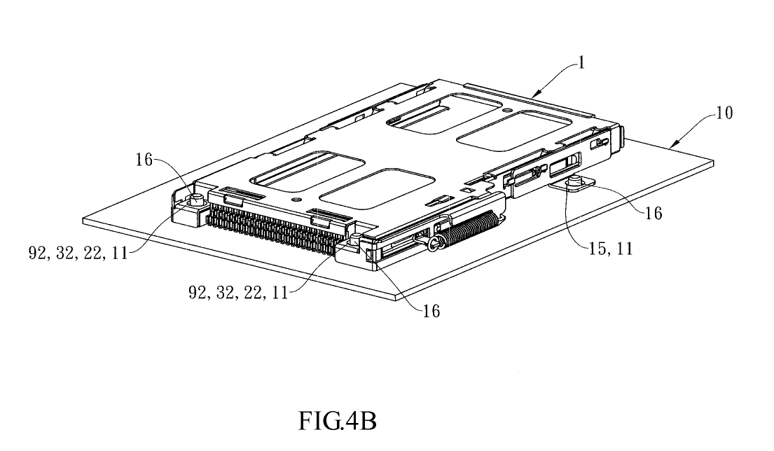

Referring to FIG. 4A and FIG. 4B, installation of the card connector 1 with the circuit board 10 is shown, before and after assembly, respectively. The circuit board 10 has a plurality of third apertures 11 corresponding in position to the fastener holes 92 and the fastener holes 15, respectively. The card connector 1 is moved in the direction indicated by the downward arrow shown in FIG. 4A until the card connector 1 becomes positioned on the circuit board 10 and causes the fastener holes 92, the first apertures 32, and the second apertures 22 to align with (the lower left and lower right ones of) the third apertures 11 and the fastener holes 15 to align with (the upper left and upper right ones of) the third apertures 11, respectively, such that the fastener holes 92, the first apertures 32, the second apertures 22, and the fastener holes 15 overlap the third apertures 11 in top-to-bottom order, respectively.

The card connector fixing device of the invention further includes a plurality of fixing elements 16 (such asz screws) corresponding in position to the third apertures 11 of the circuit board 10, respectively. The plurality of fixing elements 16 are moved in the direction indicated by the upward arrow shown in FIG. 4A. Due to the aforesaid movement of the fixing elements 16, two said fixing elements 16 (for example, long screws shown in FIG. 4A) penetrate, in bottom-to-top order, the third apertures 11 of the circuit board 10, the second apertures 22 of the positioning portions 21, and the first apertures 32 of the tabs 31, respectively, so as to be secured to the fastener holes 92 of the extension portions 91, respectively. Due to the aforesaid movement of the fixing elements 16, two other said fixing elements 16 (for example, short screws shown in FIG. 4A) penetrate, in bottom-to-top order, the third apertures 11 of the circuit board 10, respectively, so as to be secured to the fastener holes 15 of the base 14, respectively. In doing so, the card connector 1 is fixed to the circuit board 10.

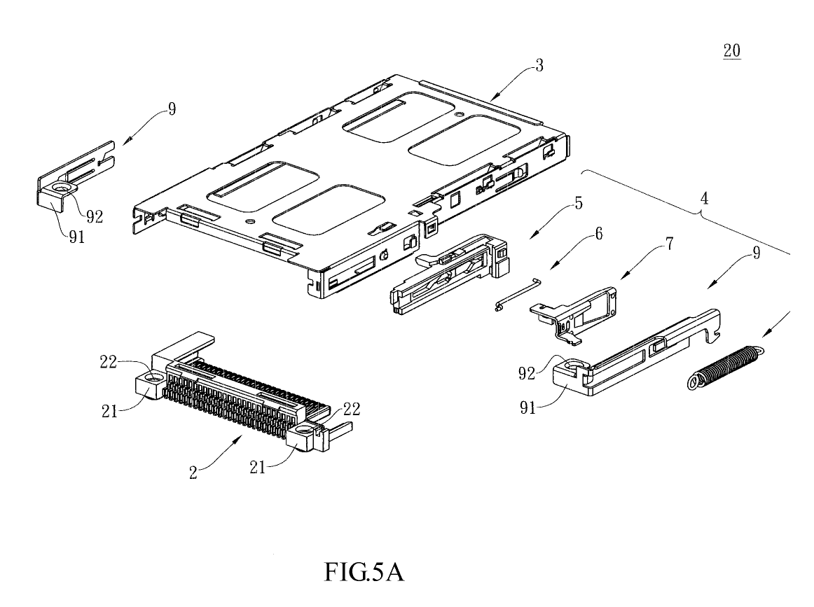

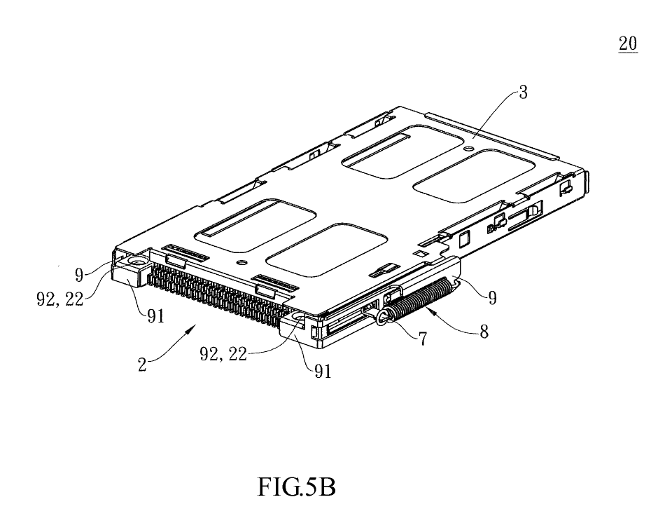

Referring to FIG. 5A and FIG. 5B, another card connector 20 according to the invention is shown, which is different from the card connector 1 in that: unlike the casing 3 in the embodiment shown in FIG. 1 through FIG. 4B, the casing 3 in the card connector 20 does not have the tabs 31 and the first apertures 32. The other components of the card connector 20 and the way of securing the components to a circuit board are the same as that of the card connector 1 and thus are not repeatedly described herein for the sake of brevity.

Advantages of a card connector fixing device of the present invention are as follows: unlike conventional card connectors, a card connector fixing device according to the invention includes a plurality of fixing elements which penetrate, in bottom-to-top order, third apertures of a circuit board, second apertures of positioning portions, first apertures of tabs, so as to be secured to fastener holes of extension portions, respectively, as well as a plurality of fixing elements which penetrate, in bottom-to-top order, the third apertures of the circuit board so as to be screwed to fastener holes of bases. The card connector is firmly secured to the circuit board in a stable manner. Accordingly, the card connector fixing device of the present invention is advantageously space-saving, structurally simple, easy to manufacture and assemble, and cost-saving.

The above detailed description of preferred embodiments of the present invention enables persons skilled in the art to fully understand that various changes and modifications can be made to the disclosure in the present invention without departing from the claims set forth hereunder and the spirit embodied in the present invention, and that the present invention is not limited by the way of implementation of the preferred embodiments described in the specification.

1. A card connector fixing device, comprising:
an insulating body;
a casing coupled to the insulating body; and
a disconnecting mechanism having a brace with a fastener hole, the brace positioned on a lengthwise side of the casing;
wherein the fastener hole corresponds to apertures in the insulating body and the casing.

2. The card connector fixing device of claim 1, wherein the disconnecting mechanism includes a resilient element having an end coupled to a side of the brace.

3. The card connector fixing device of claim 2, wherein the casing includes a base positioned on a lengthwise side of the casing and distal to the insulating body.

4. The card connector fixing device of claim 3, wherein the base includes a base fastener hole that corresponds to a board aperture in a circuit board.

5. The card connector fixing device of claim 1, wherein the casing includes a base positioned on a lengthwise side of the casing and distal to the insulating body

6. The card connector fixing device of claim 5, wherein the base includes a base fastener hole that corresponds to a board aperture.

7. The card connector fixing device of claim 1, further comprising an extension portion at the end of the brace and extending toward the casing.

8. The card connector fixing device of claim 7, wherein the brace has a substantially L-shaped body.

9. The card connector fixing device of claim 7, wherein the extension portion includes the fastener hole.

10. The card connector fixing device of claim 9, wherein the casing includes a tab corresponding in position to the extension portion of the brace.

11. The card connector fixing device of claim 10, wherein the tab includes the aperture of the casing.

12. The card connector fixing device of claim 11, wherein the insulating body has a positioning portion corresponding in position to the tab of the casing.

13. The card connector fixing device of claim 12, wherein the positioning portion includes the aperture of the insulating body which corresponds in position to the aperture in the tab.

14. The card connector fixing device of claim 13, further comprising a fastening element for securing the insulating body and the casing to a circuit board, the fastening element extends through the circuit board, the fastener hole, and the apertures in the insulating body and the casing.

15. The card connector fixing device of claim 1, further comprising a fastening element for securing the insulating body and the casing to a circuit board, the fastening element extends through the circuit board, the fastener hole, and the apertures in the insulating body and the casing.
